(19) United States
(12) Patent Application Publication
(10) Pub. No.: US 2014/0272203 A1
(43) Pub. Date: Sep. 18, 2014

(54) DECORATIVE PANEL SYSTEM

(71) Applicant: Stephen Boychuk, Toronto (CA)

(72) Inventor: Stephen Boychuk, Toronto (CA)

(21) Appl. No.: 14/210,542

(22) Filed: Mar. 14, 2014

(30) Foreign Application Priority Data
Mar. 18, 2013 (CA) 2810376

(51) Int. Cl. B44F 9/00; B32B 7/04

(52) U.S. Cl. CPC B44F 9/00; B32B 7/04
USPC 428/14; 156/69

(57) ABSTRACT

A decorative panel formed from layers comprising a transparent or translucent display panel, a supporting panel, an interchangeable decorative panel disposed between the display panel and the supporting panel, and a retaining band for surrounding the periphery of the panels and retaining the layers in generally abutting relation. The retaining band is removable so as to permit replacement of the decorative layer. The panel system of the invention provides a cost effective means of changing the look of cabinetry that is easy to implement and results in little wastage of materials.

### FIELD OF INVENTION

This invention relates to decorative panels for cabinetry and the like.

### BACKGROUND OF THE INVENTION

Interior cabinetry, for example kitchen cabinetry, utilizes “facings” including doors and drawers to close the cabinetry and conceal the cabinet or drawer interior. Such facing is often decorative, with myriad different styles and textures to choose from. The selected style and texture creates a ‘look’ intended to have aesthetic appeal.

There are different types of panels used for this purpose. Solid panels can be made out of materials such as glass, plastic or wood. The main characteristic of this design is that the solid material supports the mounting and handle hardware as well as concealing the area that the panel is designed to cover. The panels are permanently finished in one of a variety of ways. A second type of panel is framed. This type of panel is characterized by a frame made of wood, metal or plastic, which supports the mounting and handle hardware, while the panel fills in the area inside the frame. Other types of panels include modern hybrids where a glass or translucent plastic panel are affixed to a frame or affixed to a solid panel by glues, fasteners or clasps. In all of these cases the frame and panel can be finished in different materials, colors and textures, but with the exception of wood panels, the surface finish of the assembled panel is permanent and unalterable.

Even in the case of wood panels there are limitations on the ability to alter the surface aesthetics. It is unusual in today's age for wood facings to be hand painted. Typically they are pre-formed with a synthetic surface covering such as Masonite (Trademark), which cannot be covered over in any durable fashion; or factory-finished with a stain and/or varnish that is difficult to paint over, requiring extensive labour to remove the existing finish, with attendant costs. Moreover, even where the consumer or commercial user could change the facings using a paint or varnish, for example where the facings have a wood surface, it is virtually impossible to reproduce the surface finish with the same quality as a factory can.

Accordingly, the conventional way of changing the “look” of a kitchen, bathroom, laundry room or other cabinetry-based room is to reface the cabinets. This involves removing the existing facings from cabinet boxes and drawers, and replacing them with new facings. This is relatively expensive, and results in a lot of wasted material because the removed facings (usually custom-fitted to the cabinetry) must typically be discarded.

It would accordingly be advantageous to provide facings for cabinetry that can be aesthetically altered at low cost and with little wasted material.

### BRIEF DESCRIPTION OF THE DRAWINGS

In drawings which illustrate a preferred embodiment of the invention by way of example only:

FIG. 1 is a front perspective view of a panel embodying the invention.

FIG. 2 is an exploded perspective view of the panel of FIG. 1 showing the arrangement of layers in the panel of FIG. 1.

FIG. 3 is a side cross-section of the panel of FIG. 1.

FIG. 4 is a plan view of an edge of the panel of FIG. 1 showing one manner of closing the retaining band.

FIG. 5 is a cross-section of a further embodiment of the retaining band.

### DETAILED DESCRIPTION OF THE INVENTION

This invention provides a facing system for cabinetry that can be aesthetically altered at low cost and with little wasted material, requiring replacement solely of an aesthetic insert. The design of the facing system makes it easy to disassemble and replace a colored or textured insert. The system of the invention is thus ideal for decorative cabinetry. The panel of the invention is particularly especially effective as a drawer front panel or cabinet door for kitchen, bathroom or other decorative cabinets. However, while the invention is described below in the environment of cabinetry, it also can be applied to appliance surfaces and other surfaces including partitions, dividers and wall panels.

The dimensions of the panel can be made to meet standard or custom cabinet specifications, and can be manufactured with the cabinetry or supplied as a replacement for existing cabinetry in refacing situations. Standard mounting and handle hardware can be installed using conventional methods and tools.

The invention provides a decorative panel comprising a transparent or translucent display layer, a supporting layer, a decorative layer, disposed between the display layer and the supporting layer, and a retaining band for surrounding the periphery of the layers and retaining the layers in generally abutting relation, the retaining band being removable so as to permit replacement of the decorative layer.

The invention further provides a method of forming a panel, comprising the steps of: a. interposing a decorative layer between a display layer and a supporting layer, and b. affixing a retaining band around a periphery of the layers to retain the layers in generally abutting relation, the retaining band being removable so as to permit replacement of the decorative layer.

FIGS. 1-3 illustrate one embodiment of a decorative panel 10 according to the invention. The panel 10 comprises a front surface 12, a top edge 14, side edges 16, 18 and a bottom edge 20 defined by a retaining band 40, and a rear surface 22. The panel 10 is suitable for mounting to cabinetry, appliances or any other structure in which a decorative surface is desired.

FIG. 2 illustrates the layers of the panel 10 in exploded view. The panel 10 comprises a transparent or translucent layer such as a display panel 30, an interchangeable layer such as decorative insert 32, and a supporting layer such as back panel 34, held together in surface-abutting relation as an integral unit (as shown in FIG. 3) by a retaining band 40.

In the preferred embodiment the display panel 30 is transparent or translucent, being formed from glass or plastic, allowing light to pass through so that the interchangeable insert 32 is visible behind the display panel 30. The back panel 34 is preferably rigid and strong enough to support the mounting and handle hardware, composed for example from medium density fibreboard (MDF) or another low cost material. The back panel can alternatively be made of a frame and panel combination. This would be used for either large panels where weight is a concern or for doors/drawers where a more elegant aesthetic is desired. The interchangeable insert 32, which provides the decorative finish in the assembled panel 10, is held in abutting relation between the front display panel 30 and the back panel 34.

These components are held together by a removable retaining band 40 preferably having a U-shaped cross section (best seen in FIG. 3), forming a shallow channel having a floor 40a and sides 40b, 40c. The retaining band 40 may be formed (for example stamped or extruded) from aluminum, sheet steel, plastic or any other suitable material.

The retaining band 40 can be opened and closed, allowing for easy assembly and disassembly of the panel 10. The retaining band 40 is preferably formed as one piece. The ends of the retaining band 40 are butted up against one another and the retaining band 40 may be held in the closed position with a fastener affixing each end of the retaining band 40 to the back panel 34, as shown in FIG. 4. In the case of larger panels, the retaining band 40 may be made of two portions (not shown), with a fastener at each end affixing the portion of the retaining band 40 to the back panel 34 in abutting relation. The fasteners 42 are preferably positioned along the retaining band 40 so as to be hidden from sight from a normal viewing position. For example, the fasteners may be wood screws which are countersunk and located along an edge of the panel that is difficult to see, such as the top edge of an upper cupboard door or the bottom edge of a drawer face.

One side 40b of the channel engages into a groove 30a surrounding (or partly surrounding) the perimeter of the display panel 30. In the preferred embodiment the portion of the display panel 30 which sits in the channel is recessed, as shown at 46 in FIG. 3, so that the retaining band 40 is flush with or slightly inset from the bottom edge of the display panel 40. The retaining band 40 is thus largely concealed from view when observed from the front of the panel 10. The other side 40c of the channel rests in a notch 34a surrounding (or partly surrounding) the perimeter of the back panel 44, preferably (but not necessarily) adjacent to its rear surface. The notch 34a is also preferably recessed from the outer edge of the back panel 34 such that the exterior face of the retaining band 40 is flush with the side edge of the back panel 34. Thus, in the embodiment illustrated the back panel 44 and interchangeable insert 32 are slightly smaller in dimension than the front surface of the display panel 40. This generally conceals the side 40b of the channel, for aesthetic purposes, but also avoids the collection of dirt and grime, or the seepage of liquids which may spill or spray onto the front surface of panel 10 into the channel of the retaining band 40, which is particularly advantageous in a kitchen or bathroom.

The visible exterior surfaces of the retaining band 40 are preferably decorative also, since at least some of these surfaces are visible when the panel 10 (for example a cabinet door or drawer face) is in the open position. The interchangeable insert 32 preferably (but not necessarily) fills the entire available area within the retaining band 40, to thus overlay the entirety of the back panel 34.

The length of the side 40c of the retaining band 40, which extends about the rear face of the back panel 34, is formed as necessary so as to not interfere with door hinge hardware, but is large enough to securely grip the back panel 34 and may have a slight acute angle so that the flexible band can compensate for different thicknesses of insert or manufacturing tolerances. The side 40b the retaining band 40 is preferably made as small as possible so as not to interfere with direct visibility of the interchangeable insert, while being large enough to hold the display panel 30 securely in position. The sides 40b, 40c of the retaining band 40 are mitered at the corners so as to allow the retaining band 40 to close properly around the panel 10.

To form the panel 10, an interchangeable insert 32 of the appropriate size is positioned between a display panel 30 and a back panel 34. The retaining band 40 is placed around the periphery of the composite panel arrangement, such that the side 40b sits in the groove 30a and the side 40c sits in the notch 34a. In the preferred embodiment a bead 40d formed along the rear side of the retaining band 40 seats in a complementary groove 34b formed at the end of the notch 34a, either continuously or intermittently around the periphery of the panel 10. In this embodiment, when the retaining band 40 is disposed over the edge of the panel 10 the bead 40d is lodged in the groove 34b so as to prevent the retaining band 40 from dislodging along the direction of the plane containing the panel 10.

The retaining band is fastened to the panel 10, and simultaneously into the closed position, by fasteners 42 disposed through the projecting tongues 43 and into the side edges of the back panel 34. The panel 10 assembled in this manner can be mounted to a drawer, cabinet box or other structure in conventional fashion.

To change the decor of the panel, the fasteners 42 are removed to open the retaining band 40, removing the side 40b from the groove 30a around the perimeter of the display panel 30 and the side 40c from the notch 44a about the back panel 34, and thus releasing the display panel 30 from the back panel 34. The panel 10 can then be reassembled, as described above, with a different decorative insert 32 disposed between the display panel 30 and the back panel 34.

FIG. 5 illustrates a further embodiment of the retaining band 40 having ribs 40e which aid in straight forming the band 40 through an extrusion die. In this embodiment the back panel 34 comprises an overlay 48, for example formed from transparent or translucent acrylic sheet. The overlay may be laminated to the wood portion of the back panel 34 as illustrated, or may be held in position against the wood portion of the back panel 34 by the retaining band 40, which would allow a further decorative insert panel (not shown) to be mounted between the wood portion of the back panel 34 and the acrylic overlay 48, for example to impart a decorative finish to the back of a cupboard door. In this embodiment the notch 34a and groove 34b are formed in the acrylic portion 48 of the back panel 34.

Modifications of the invention may be made without departing from the scope of the invention described herein. For example, without limitation, the decorative insert 32 may be adhered to the back panel 34 or the display panel 30; other layers, partial layers and hybrid layers may be added or substituted for the layers illustrated (for example a decorative layer may be applied to or fixed within the retaining band 40 overlaying the rear surface of the back panel 34); and the display panel 30 may be provided with a colour and/or texture to complement or add design elements to the decorative insert layer 32. The invention includes all such modifications and adaptations as fall within the scope of the accompanying claims.

We claim:

1. A decorative panel, comprising:
a transparent or translucent display layer,
a supporting layer,
a decorative layer, disposed between the display layer and the supporting layer, and
a retaining band for surrounding the periphery of the layers and retaining the layers in generally abutting relation, the retaining band being removable so as to permit replacement of the decorative layer.

2. The panel of claim 1 wherein the retaining band comprises a unitary, channel-shaped band which is sufficiently flexible as to close around the panel and open to be removed from the panel.

3. The panel of claim 2 wherein a front side of the channel engages into a groove at least partly surrounding a perimeter of the display layer.

4. The panel of claim 3 wherein a portion of the display layer which sits in the channel is recessed such that the retaining band is flush with or slightly inset from the bottom edge of the display layer.

5. The panel of claim 2 wherein a rear side of the channel rests in a notch at least partly surrounding a perimeter of the supporting layer.

6. The panel of claim 5 wherein the notch is adjacent to a rear surface of the supporting layer.

7. The panel of claim 5 wherein the notch is recessed from an outer edge of the supporting layer such that an exterior face of the retaining band is generally flush with a side edge of the supporting layer.

8. The panel of claim 2 wherein a rear side of the channel is provided with an intermittent or continuous bead seated in a groove formed along a periphery of the supporting layer, to prevent the retaining band from dislodging in a direction of a plane containing the panel.

9. The panel of claim 1 wherein the back panel comprises a wood portion and an overlay portion.

10. The panel of claim 9 wherein the overlay portion is transparent or translucent, permitting a second decorative layer to be disposed between the wood portion and the overlay portion to impart a decorative finish to the back of the panel.

11. A method of forming a panel, comprising the steps of:
a. interposing a decorative layer between a display layer and a supporting layer, and
b. affixing a retaining band around a periphery of the layers to retain the layers in generally abutting relation, the retaining band being removable so as to permit replacement of the decorative layer.

12. The method of claim 11 wherein the retaining band comprises a unitary, channel-shaped band which is sufficiently flexible as to close around the panel and open to be removed from the panel.

13. The method of claim 12 comprising the sub-step, during step b., of engaging a front side of the channel into a groove at least partly surrounding a perimeter of the display layer.

14. The method of claim 13 wherein a portion of the display layer which sits in the channel is recessed such that the retaining band is flush with or slightly inset from the bottom edge of the display layer.

15. The method of claim 12 comprising the sub-step, during step b., of disposing a rear side of the channel in a notch at least partly surrounding a perimeter of the supporting layer.

16. The method of claim 15 wherein the notch is adjacent to a rear surface of the supporting layer.

17. The method of claim 15 wherein the notch is recessed from an outer edge of the supporting layer such that an exterior face of the retaining band is generally flush with a side edge of the supporting layer.

18. The method of claim 12 comprising the sub-step, during step b., of lodging an intermittent or continuous bead provided about a rear side of the channel into a groove formed along a periphery of the supporting layer, to prevent the retaining band from dislodging in a direction of a plane containing the panel.

19. A kit of parts for producing the panel of claim 1.
